(19) United States
(12) Patent Application Publication
(10) Pub. No.: US 2016/0180971 A1
(43) Pub. Date: Jun. 23, 2016

(54) Magnetic Torsion Accelerator

(71) Applicant: Michael Peavey, Louisville, KY (US)

(72) Inventor: Michael Peavey, Louisville, KY (US)

(21) Appl. No.: 14/757,017

(22) Filed: Nov. 6, 2015

Related U.S. Application Data
(60) Provisional application No. 62/123,026, filed on Nov. 6, 2014.

(51) Int. Cl. G21B 1/05; G21B 1/21

(52) U.S. Cl. CPC G21B 1/05; G21B 1/21

(57) ABSTRACT

Cyclic fusion device using magnetic shear and reconnection to convert the heat content and conductivity of plasma into directional motion at higher temperature for sustained energy.

### CROSS REFERENCE TO RELATED APPLICATIONS

This application claims priority from U.S. Provisional Application Ser. No. 62/123026 filed on Nov. 6, 2014.

### TECHNICAL FIELD

The present invention relates generally to a cyclic fusion device with a magnetic confinement chamber for compressing heated plasma away from the confinement chamber wall.

### BACKGROUND OF THE INVENTION

This invention refers to magnetic confinement fusion reactors. Increasing plasma temperature lowers conductive resistance and limits temperature to about 3×10⁷ K (2× the core of the sun). 10⁸ K is needed for man-made fusion.

On the sun, thermal convection drives charged particles thru the poloidal magnetic field, shearing the field until the lines cross, and recombine, thereby thrusting plasma outward 100's of times faster and hotter than on the surface.

The present invention uses magnetic shear and reconnection to store and release the potential energy in heated plasma. Magnetic field lines shear and reconnect, thereby releasing plasma with directional motion and higher temperature for sustained cycles of fusion events.

### SUMMARY OF THE INVENTION

Expansion and acceleration of plasma converts the random energy of charged particles into directional motion at a higher temperature to induce voltage in passive coils. No external particle injection is needed. Hydrogen isotopes, deuterium and tritium, travel at different speeds and produce different products with different charge/momentum ratios.

²H+³H→⁴He+n°→17.59 MeV

²H+³He→⁴He+p+→18.3 MeV

Synchrotron radiation is absorbed in ion orbits with random directions. The rebounding mirror and torsion fields compress all charges radially, regardless of orbital direction.

A cyclic fusion device with a magnetic confinement chamber compresses heated plasma away from the chamber wall. A poloidal magnetic flux path extends through the center of the confinement chamber. Rotating magnetic fields centered around the poloidal flux path twist the field lines within the confinement chamber, thereby storing potential energy in a torsion field. Electric discharge through the poloidal flux path releases energy stored in the torsion field into plasma with directional motion at a higher temperature to sustain power output. The thrust path ejects the fusion energy for rocket propulsion or electric power.

The instant invention comprises or consists of a device with means of magnetic shear and reconnection to generate fusion energy for propulsion, electric power, or scientific research. The apparatus includes means of generating a magnetic confinement field within a spherical magnetic confinement chamber containing fuel suitable for nuclear fusion comprising means of poloidal magnetic flux path intersecting the confinement field and magnetic confinement chamber; means wherein rotating magnetic fields twist the field lines of the poloidal magnetic flux path, thereby storing potential energy in a torsion field, within the magnetic confinement chamber; means of electric discharge across the poloidal magnetic flux path to release potential energy in the torsion field to generate nuclear fusion events in the magnetic confinement chamber; and electromagnetic means of accelerating the kinetic energy from the magnetic confinement chamber for propulsion, electric power, or research.

Moreover, the poloidal magnetic flux path can intersect any spherical, toroidal, or other shape, of the magnetic confinement chamber designed for nuclear fusion events.

One, two, or more of the rotating magnetic fields, use electromagnetic, or mechanical means, or a combination of both.

Inertial confinement means, such as lasers, may augment the magnetic shear and reconnection processes of this invention.

Solids, liquids, gas or a vacuum may be used, or tested, for reactions to magnetic shear and reconnection.

More particularly, the magnetic torsion accelerator includes a spherical confinement chamber and a magnetron with a wave guide directing microwave energy into the spherical confinement chamber for heating and ionizing hydrogen gas to a fusion reaction state. Plasma is produced within a chamber wall thereof creating magnetic shear and reconnection accelerating electrons and ion steams spinning around the center of a torsion shear field. A first 3-phase electric induction stator and a second 3-phase electric induction stator generate counter-rotating magnetic fields forming a twisting poloidal flux path into a torsion field within the spherical confinement chamber. A first pair of pinch coils and a second pair of pinch coils confine stray flux. An electric induction motor with a 3-phase alternating current supply generates a rotating magnetic field in a rotor. The rotor turns at a slower speed than the magnetic field in an induction stator inducing current in the rotor. The first 3-phase electric induction stator and the second 3-phase electric induction stator are counter-rotating thereby doubling their relative speed and converging in a center of the torsion field adding energy to the fusion reaction. A magnetic baseball shaped confinement coil centering the shear field in a x-axis extends through a thrust path with the coils. A y-axis extends through a center of a poloidal flux path, and a z-axis extends through a center of the spherical confinement chamber forming an undulating pattern following a path resembling the shape of the stitches on a baseball generating a confinement field. The baseball confinement coil having tightly wound windings produces a dense magnetic field wherein adjusting an angle of the windings deepens a magnetic trap leaving a minimum of 10 centimeters of vacuum gap between the plasma and the chamber wall. A group of diversion loop coils form a circuit with a capacitor in electrical communication with a plurality of thrust path coil diodes directing the flux inward. The poloidal flux path induces current in the group of diversion loop coils charging the thrust path coil diodes and the capacitor. The induced current produces a mirror field within the spherical confinement chamber compressing the torsion field within the spherical confinement chamber. A laser produces beams converging inside the spherical confinement chamber. A variable resistor tunes a discharge from the capacitor. The capacitor includes a vacuum dielectric for sustaining a high voltage with low losses avoiding a high degradation rate. The capacitor has a high ratio of plate area to separation increasing capacitance producing voltage high enough to cut through the magnetic field lines releasing energy stored in the shear field. The discharge of the capacitor severs the poloidal flux path and the group of diversion loop coils reverse the flux direction. The current reverses the thrust path diodes directing flux outward in an ejection mode severing the poloidal flux path releasing energy from the torsion field expanding and inwardly compressing the mirror field against an electrically conductive wall of the spherical confinement chamber. The mirror field rebounding off of a spherical confinement chamber wall compresses the torsion field. Inward compressing of the mirror field and the torsion field heats the plasma to the fusion state. The capacitor may include ceramic capacitor plates. The wave guide may be a 60 MHZ wave guide.

Other objects, features, and advantages of the invention will be apparent with the following detailed description taken in conjunction with the accompanying drawings showing a preferred embodiment of the invention.

### BRIEF DESCRIPTION OF THE DRAWINGS

A better understanding of the present invention will be had upon reference to the following description in conjunction with the accompanying drawings in which like numerals refer to like parts throughout the views wherein:

FIG. 1 is a perspective diagram showing components of a standard TOKAMAK magnetic confinement fusion reactor;

FIG. 2 is an expanded perspective diagram showing the assembly of the major components of the invention;

FIG. 3 is a perspective diagram of a Baseball Confinement Field with three axes;

FIG. 4 is a schematic cross-section of a spherical confinement chamber wherein the thrust path coils are tapped in confinement mode and the flux path points inward;

FIG. 5 is a schematic cross-section of a spherical confinement chamber wherein the thrust path coils are tapped in ejection mode and the flux path points outward; and

FIG. 6 is a schematic diagram of alternating current (“A.C.”), power supplied to a 3-phase electric induction stator rotating in time with alternating current oscillations.

### DESCRIPTION OF THE PREFERRED EMBODIMENTS

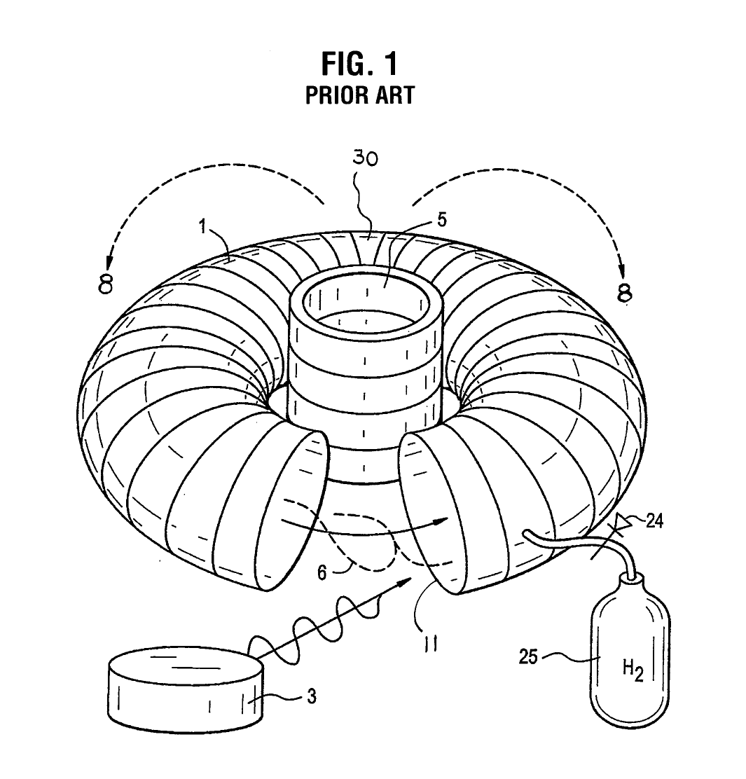

As shown in FIG. 1, a conventional prior art toroidal magnetic confinement chamber 1 with a toroidal field coil 5. A poloidal field 8 intersects the toroidal flux coil 30 to produce a resultant torsion field 6 that confines plasma away from the chamber wall 11. Fuel flows through a metering valve 24 from the fuel storage 25 to confinement chamber. A magnetron 3 with wave guide heats hydrogen fuel to a fusion state.

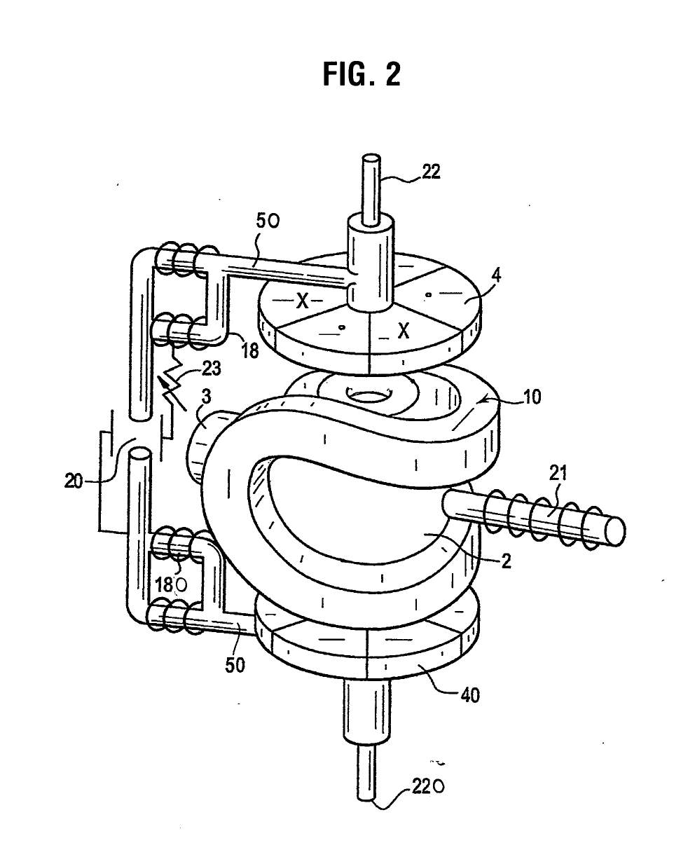

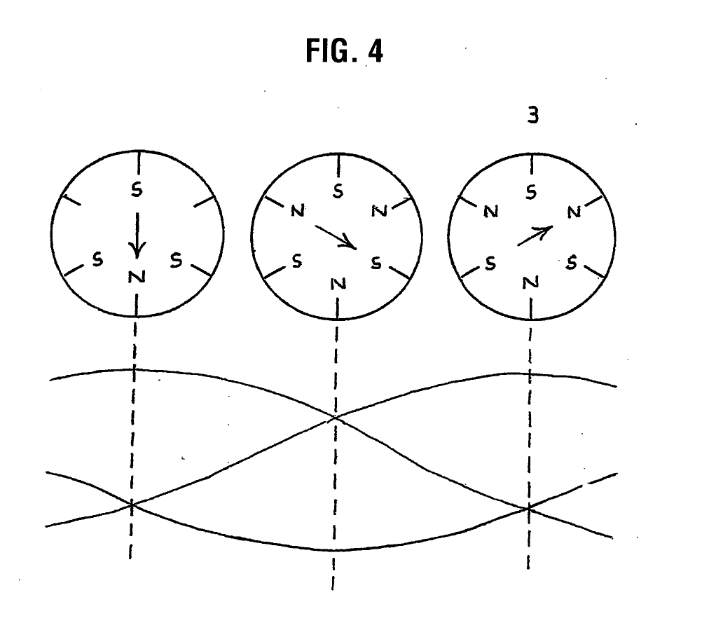

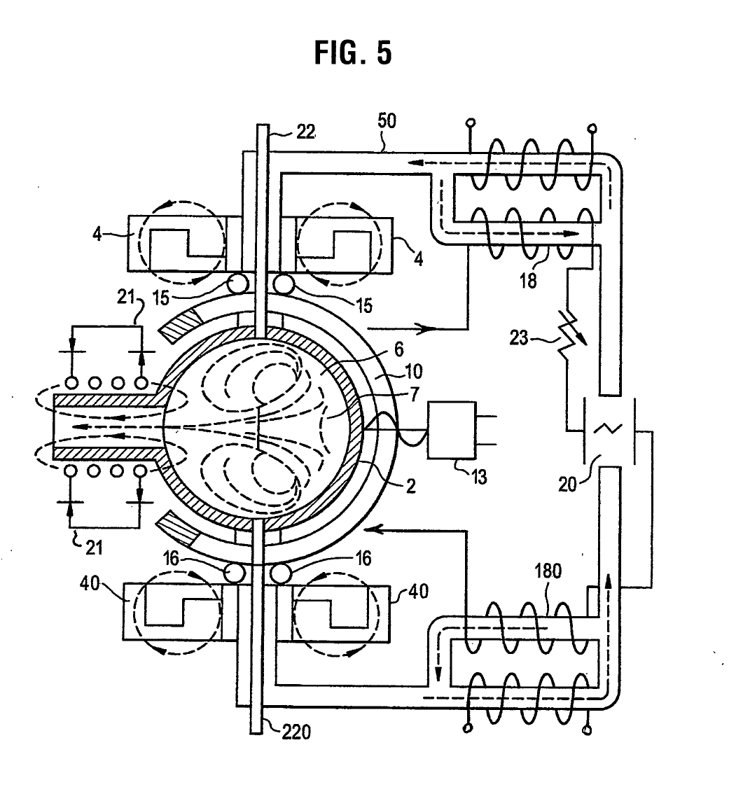

The present invention as shown in FIG. 2, comprises or consists essentially of a spherical confinement chamber 2. A magnetron 3 directs microwave energy into the spherical confinement chamber 2 to heat the plasma. A first 3-phase electric induction stator 4 and second 3-phase induction stator 40 generate counter-rotating magnetic fields within poloidal flux path 50. Electric induction motors eliminate commutators or slip rings. A typical 3-phase A.C. supply generates a rotating magnetic field in the rotor. The rotor turns at a slower speed than the magnetic field in the stator. The difference in speed induces current in the rotor. The present invention uses only the stators to generate rotating fields moving much faster than a mechanical rotor. In the instant invention, a pair of induction stators counter-rotate doubling their relative speed. A coil 10 forming an undulating pattern following a path resembling the shape of the stitches on a baseball define a baseball confinement coil 10 and generates a confinement field. The baseball confinement coil is tightly wound to produce a dense magnetic field. Adjusting the angles of the windings, deepens the magnetic trap leaving a minimum 10 cm vacuum gap between the plasma and chamber wall. A first group of diversion loop coils 18 and a second group of diversion loop coils 180 form a circuit with capacitor 20 in electrical communication with thrust path coils 21 as depicted in FIGS. 2, and defined in FIGS. 4 and 5 as thrust path diodes tapped in confinement mode). Laser beams 22 and 220 converge inside spherical confinement chamber 2. A variable resistor 23 allows manual tuning of the capacitor 20 discharge as shown in FIG. 5. The capacitor 20 includes a vacuum dielectric which sustains a high voltage with low losses and avoids the high degradation rates of other dielectrics. A high ratio of plate area to separation, increases capacitance. The breakdown voltage must be high enough to cut thru the magnetic field lines to release the energy stored in the shear field. Ceramic capacitor plates have the lowest equivalent series resistance. Direct current minimizes heating.

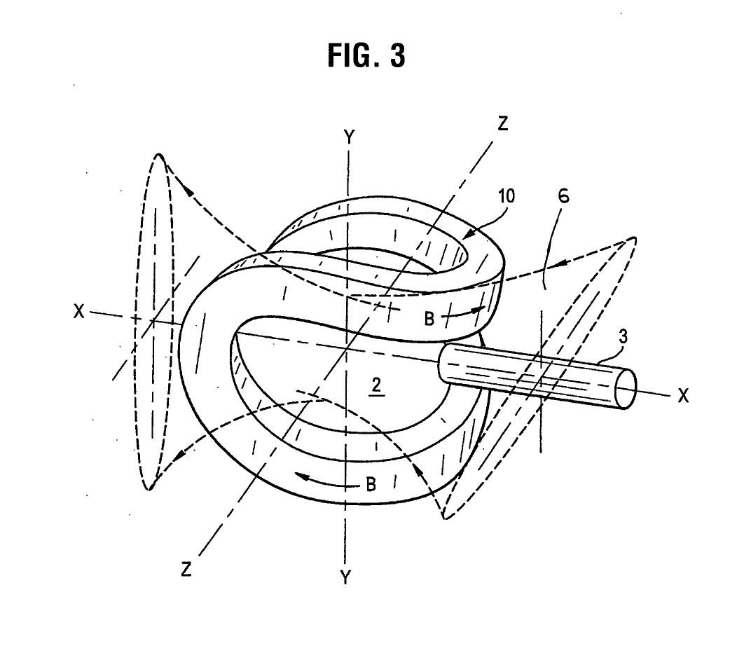

The magnetic baseball shaped confinement coil 10 as shown in FIG. 3, illustrates how the magnetic shear and reconnection accelerates electrons and ion streams spinning around the center of the torsion shear field 6. The magnetic baseball coil 10 centers the shear field on three axes, the X, Y, and Z axis. The X axis extends through the thrust path with coils. The Y axis extends through the center of the poloidal flux path. The Z axis is directed through the center of spherical confinement chamber 2.

FIG. 4 is a schematic cross-section of this invention in confinement mode showing the thrust path coils 21 directing the flux inward. The thrust path coils with diodes 21 direct flux inward.

### Energy Inputs

External current provide the energy inputs which activates the magnetron 3 with the wave guide 13. Commercial magnetrons used with confinement chambers use an approximate 60 MHZ wave guide. Conductors must be safely grounded. Feeder excitation voltage maximum is 40 kV along the current probe and about 250 kV inside the wave guide, an electric field maximum is around 30 kV per cm. The first 3-phase electric induction stator 4 and the second 3-phase electric induction stator 40 generate the counter-rotating magnetic fields within the poloidal flux path 50 where the coils 18 and 180 form a circuit with the capacitor 20 and the laser beams 22 and 220 converge inside the spherical confinement chamber 2 wherein plasma follow undulating path of the baseball confinement coil 10 generating the confinement field

### Internal Circuit

The poloidal flux path 50 induces current in diversion loop coils 18 and 180, charging the thrust path coil diodes 21 and capacitor 20. The variable resister 23 allows manual tuning of the capacitor 20 discharge.

### Shear Field

The magnetron 3 with the wave guide 13 ionizes hydrogen gas within the spherical confinement chamber 2. The 3-phase electric induction stators 4 and 40 generate magnetic fields turning in opposite directions, twisting the poloidal flux path 50 into a torsion field 6 within the spherical confinement chamber 2. A first pair of pinch coils 15 and a second pair of pinch coils 16 confine stray flux.

### Mirror Field

The magnetic baseball confinement coil 10 induces current in the conductive shell of the spherical confinement chamber 2. Induced current produces mirror field 7 inside the spherical confinement chamber 2, compressing the torsion field 6 within the spherical confinement chamber 2. Inertial confinement laser beams 22 and 220 pass through a first pair of 3-phase electric induction stators 4 and a second pair of 3-phase electric induction stators 40 converge in the center of the torsion field 6 adding energy to the fusion reactions.

As best shown in ejection mode in FIG. 5, the thrust path coils 21 direct flux outward.

### Flux Reversal

Discharge of the capacitor 20 severs the poloidal flux path 50 and the diversion loops 18 and 180 reverses the flux direction. The current reverses the thrust path diodes 21 directing flux outward in the ejection mode.

### Fields Expand

The severed poloidal flux path 5 releases energy from the torsion field 6 which expands and compresses the mirror field 7 against the electrically conductive wall of the spherical confinement chamber 2.

### Fields Rebound

The mirror field 7 rebounds off of the spherical confinement chamber 2 wall compressing the torsion field 6. The inward compression of the mirror field 7 and torsion field 6 heat the plasma to a fusion state. The thrust path diodes 21 accelerate ejecting the plasma outward.

### Inertial Confinement

Lasers 22 pass through a first pair of 3-phase electric induction stators 4 and a second pair of 3-phase electric induction stators 40 to converge in the center of the torsion field 6 adding energy to the fusion reactions. The variable resistor 23 allows for manual tuning of the capacitor discharge.

### Return to Confinement Mode

The first pair of 3-phase electric induction stators 4 and a second pair of 3-phase electric induction stators 40 continue to store energy in the torsion field 6. The spherical baseball confinement coil 10 continues to generate the mirror field 7 and the magnetron 2 with the wave guide 13 heats the plasma within the spherical confinement chamber 2 and the pinch coils 15, and 16 confine the stray flux.

### Energy Output

Accelerated ions can be converted to direct electric output by adding a passive coil to the thrust path. The thermal energy output is converted to electricity by heat exchange means well known in nuclear science. The means include molten salts as primary heat exchange media. Primary media heats water for steam turbines.

FIG. 6 illustrates a diagram of alternating current supplied to the first pair of 3-phase electric induction stators 4 and a second pair of 3-phase electric induction stators 40 that creates a magnetic field rotating in time with alternating current oscillations. Fields counter-rotate doubling their relative speed twisting the poloidal flux path 50 into a torsion field 6.

1. A magnetic torsion accelerator, comprising the steps of:
generating a magnetic confinement field within a spherical magnetic confinement chamber containing fuel suitable for nuclear fusion;
forming a poloidal magnetic flux path intersecting said confinement field and said magnetic confinement chamber;
rotating a magnetic field twisting the field lines of said poloidal magnetic flux path, thereby storing potential energy in a torsion field, within said magnetic confinement chamber;
electrically discharging across said poloidal magnetic flux path releasing potential energy in said torsion field generating a nuclear fusion events in said magnetic confinement chamber; and
electromagnetically accelerating said kinetic energy from said magnetic confinement chamber for propulsion; electric power, or research.

2. The method of claim 1 wherein said poloidal magnetic flux path intersects a spherical magnetic confinement chamber.

3. The method of claim 1 wherein the step of rotating said magnetic field uses an electromagnet.

4. The method of claim 1 wherein an inertial confinement means comprising a, laser augments a magnetic shear and a reconnection process.

5. The method of claim 1 including the step of testing a solid, a liquid, or a gas or a vacuum for a reaction to a magnetic shear and a reconnection.

6. The method of claim 1 wherein said poloidal magnetic flux path intersects a toroidal magnetic confinement chamber.

7. A magnetic torsion accelerator, comprising:
a spherical confinement chamber;
a magnetron with a wave guide directing microwave energy into said spherical confinement chamber heating and ionizing hydrogen gas to fusion reaction state producing a plasma within a chamber wall thereof creating magnetic shear and reconnection accelerating electrons and ion steams spinning around the center of a poloidal shear field;
a first 3-phase electric induction stator and a second 3-phase electric induction stator generating counter-rotating magnetic fields forming a twisting poloidal flux path into a torsion field within said spherical confinement chamber;
a first pair of pinch coils and a second pair of pinch coils confining stray flux;
an electric induction motor;
a 3-phase alternating current supply generating a rotating magnetic field in a rotor;
said rotor turning at a slower speed than the magnetic field in an induction stator inducing current in said rotor;
said first 3-phase electric induction stator and said second 3-phase electric induction stator counter-rotating thereby doubling their relative speed and converging in a center of said torsion field adding energy to said fusion reaction;
a magnetic baseball shaped confinement coil centering said shear field in a x-axis extending through a thrust path with coils, a y-axis extending through a center of a poloidal flux path, and a z-axis extending through a center of said spherical confinement chamber forming an undulating pattern following a path resembling the shape of the stitches on a baseball generating a confinement field;
said baseball confinement coil having tightly wound windings producing a dense magnetic field wherein adjusting an angle of said windings deepens a magnetic trap leaving a minimum of 10 centimeters of vacuum gap between said plasma and said chamber wall;
a group of diversion loop coils form a circuit with a capacitor in electrical communication with a plurality of thrust path coil diodes directing flux inward;
said poloidal flux path inducing current in said group of diversion loop coils charging said thrust path coil diodes and said capacitor;
said induced current producing a mirror field within said spherical confinement chamber compressing said torsion field within said spherical confinement chamber;
a laser produces beams converging inside said spherical confinement chamber;
a variable resistor tunes a discharge from said capacitor;
said capacitor including a vacuum dielectric for sustaining a high voltage with low losses avoiding a high degradation rate;
said capacitor having a high ratio of plate area to separation increasing capacitance producing voltage high enough to cut through said magnetic field lines releasing energy stored in said shear field; and
wherein discharge of said capacitor severs said poloidal flux path and said group of diversion loop coils reverse the flux direction and the current reverses the thrust path diodes directing flux outward in an ejection mode, severing said poloidal flux path releasing energy from said torsion field expanding and inwardly compressing said mirror field against an electrically conductive wall of said spherical confinement chamber, said mirror field rebounding off of a spherical confinement chamber wall compressing said torsion field, said inward compressing of said mirror field and said torsion field heating said plasma to said fusion state.

8. The magnetic torsion accelerator of claim 7, wherein said capacitor includes ceramic capacitor plates.

9. The magnetic torsion accelerator of claim 7, wherein said wave guide is a 60 MHZ wave guide.

9. The A magnetic torsion accelerator of claim 7, including adding a passive coil to said thrust path converting accelerated ions to direct electric output by adding a passive coil to the thrust path.

10. The magnetic torsion accelerator of claim 7, including a variable resister for manual tuning of said capacitor discharge.
